(19) United States
(12) Patent Application Publication
(10) Pub. No.: US 2025/0163265 A1
(43) Pub. Date: May 22, 2025

(54) TRANSPARENT POLYCARBONATE COMPOSITIONS

(71) Applicant: SHPP GLOBAL TECHNOLOGIES B.V., Bergen op Zoom (NL)

(72) Inventors: Wei Zhao, Evansville, IN (US); Laura Mely Ramirez, Evansville, IN (US); Hao Zhou, Newburgh, IN (US); Peter Hendrikus Theodorus Vollenberg, Evansville, IN (US)

(21) Appl. No.: 18/842,956

(22) PCT Filed: Feb. 28, 2023
(86) PCT No.: PCT/IB2023/051874

§ 371 Date: Aug. 30, 2024

(30) Foreign Application Priority Data
Mar. 1, 2022 (EP) 22159412.0

(51) Int. Cl. C08L 69/00; C08G 64/16

(52) U.S. Cl. CPC C08L 69/00; C08G 64/1616; C08L 2201/10

(57) ABSTRACT

A polycarbonate composition comprises: a copolycarbonate comprising repeating units derived from a cyclohexylidene-bridged bisphenol; and an auxiliary polycarbonate comprising a branched homopolycarbonate; a poly(1,4-cyclohexanedimethylene terephthalate), a copolycarbonate derived from an isophorylidene-bridged bisphenol, and optionally a poly(alkylene cyclohexanedicarboxylate), poly(carbonate siloxane) having a siloxane content of less than 20 wt % based on the total weight of the poly(carbonatesiloxane), poly(aliphatic ester-carbonate) comprising bisphenol A carbonate units and C₆₋₁₂ dicarboxy ester units; or a combination thereof. The polycarbonate compositions have one or more of a transparency of 89% or greater on 2.5 mm plaques according to ASTM-D1003-00; and a heat deformation temperature of at least 111° C., or at least 127° C. at 0.45 MPa or at least 98° C., or at least 110° C. at 1.82 MPa as determined on 3.18 mm bars per ASTM D648.

### CROSS REFERENCE TO RELATED APPLICATION

This PCT application claims priority to European Application No. 22159412.0, filed on Mar. 1, 2022, the content of which is herein incorporated by reference in its entirety.

### BACKGROUND

This disclosure relates to polycarbonate compositions, and in particular to transparent polycarbonate compositions, methods of manufacture, and uses thereof.

Polycarbonates are useful in the manufacture of articles and components for a wide range of applications, from automotive parts to electronic appliances. Because of their broad use, mixtures of polycarbonates may prepared to achieve an improvement in thermal resistance. However, when polycarbonates are mixed, there may be a loss on transparency.

There accordingly remains a need in the art for polycarbonate compositions that include two or more polycarbonates that provide good transparency and thermal resistance. It would be a further advantage if the compositions provide good scratch resistance.

### SUMMARY

The above-described and other deficiencies of the art are met by a polycarbonate composition comprising: a copolycarbonate comprising repeating units derived from a cyclohexylidene-bridged bisphenol; and an auxiliary polycarbonate comprising a branched homopolycarbonate; a poly(1,4-cyclohexanedimethylene terephthalate), a copolycarbonate comprising repeating units derived from an isophorylidene-bridged bisphenol, or a combination thereof, and optionally a poly(alkylene cyclohexanedicarboxylate), a poly(carbonate siloxane) having a siloxane content of less than 20 wt % based on the total weight of the poly(carbonate-siloxane), a poly(aliphatic ester-carbonate) comprising bisphenol A carbonate units and C₆₋₁₂ dicarboxy ester units; or a combination thereof, and optionally, an additive composition, wherein a molded sample of the composition has a transparency of 89% or greater as measured using 2.5 mm plaques according to ASTM-D1003-00.

In another aspect, a method of manufacture comprises combining the above-described components to form a polycarbonate composition.

In yet another aspect, an article comprises the above-described polycarbonate composition.

In still another aspect, a method of manufacture of an article comprises molding, extruding, or shaping the above-described polycarbonate composition into an article.

The above described and other features are exemplified by the following detailed description, examples, and claims.

### DETAILED DESCRIPTION

Polycarbonates comprising units derived from a cyclohexylidene-bridged bisphenol provide good transparency and scratch resistance. The present inventors hereof have discovered that transparency can be maintained and thermal properties can be improved for combinations of a polycarbonate comprising repeating units derived from a bisphenol cyclohexylidene and an auxiliary polycarbonate including a branched homopolycarbonate; a poly(aliphatic ester-carbonate) comprising bisphenol A carbonate units and C₆₋₁₂ dicarboxy ester units; a poly(1,4-cyclohexanedimethylene terephthalate), a copolycarbonate comprising repeating units derived from an isophorylidene-bridged bisphenol, and optionally a poly(alkylene cyclohexanedicarboxylate), a poly(carbonate siloxane) having a siloxane content of less than 20 wt % based on the total weight of the poly(carbonate-siloxane), or a combination thereof. The polycarbonate compositions can have a % transmission of 89% or greater as measured using 2.5 mm plaques according to ASTM-D1003-00. When the auxiliary polycarbonate includes a poly(aliphatic ester-carbonate), then a molded sample of the polycarbonate compositions can have a heat deformation temperature (HDT) of at least 111° C. measured at 0.45 MPa or of at least 98° C. measured at 1.82 MPa according to ASTM D648 on a 3.18 mm plaque. When the auxiliary polycarbonate includes auxiliary polycarbonates including a branched homopolycarbonate; a poly(1,4-cyclohexanedimethylene terephthalate), a copolycarbonate comprising repeating units derived from an isophorylidene-bridged bisphenol, and optionally a poly(alkylene cyclohexanedicarboxylate), a poly(carbonate siloxane) having a siloxane content of less than 20 wt % based on the total weight of the poly(carbonate-siloxane), or a combination thereof, then a molded sample of the polycarbonate compositions can have a heat deformation temperature (HDT) of at least 127° C. measured at 0.45 MPa or of at least 110° C. measured at 1.82 MPa according to ASTM D648 on a 3.18 mm plaque. The polycarbonate compositions can also have good scratch resistance.

The individual polycarbonates of the polycarbonate compositions are described in more detail below.

The polycarbonate compositions include copolycarbonate including repeating units derived from a cyclohexylidene-bridged bisphenol in combination with an auxiliary polycarbonate.

“Polycarbonate” as used herein means a polymer having repeating structural carbonate units of formula (1)

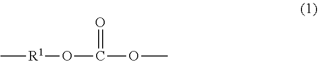

in which at least 60 percent of the total number of R¹ groups contain aromatic moieties and the balance thereof are aliphatic, alicyclic, or aromatic. In an aspect, each R¹ is a C₆₋₃₀ aromatic group, that is, contains at least one aromatic moiety. R¹ may be derived from an aromatic dihydroxy compound of the formula HO—R¹—OH, in particular of formula (2)

HO—A¹—Y¹—A²—OH (2)

wherein each of A¹ and A² is a monocyclic divalent aromatic group and Y¹ is a single bond or a bridging group having one or more atoms that separate A¹ from A². In an aspect, one atom separates A¹ from A².

The copolycarbonate including repeating units derived from a cyclohexylidene-bridged bisphenol has the structure of formula (1e), wherein t is 2 or less.

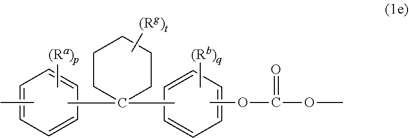

In some aspects, R^{a} and R^{b} are each independently C₁₋₁₂ alkyl, R^{g} is C₁₋₁₂ alkyl, p and q are each independently 0 to 4, and t is 0 to 2. In a specific aspect, at least one of each of R^{a} and R^{b} are disposed meta to the cyclohexylidene bridging group. In an aspect, R^{a} and R^{b} are each independently C₁₋₄ alkyl, R^{g} is C₁₋₄ alkyl, p and q are each 0 or 1, and t is 0 to 2. In another specific aspect, R^{a}, R^{b}, and R^{g} are each methyl, p and q are each 0 or 1, and t is 0.

In a specific aspect, the copolycarbonate of formula (1e) is derived from bisphenol having the following structure

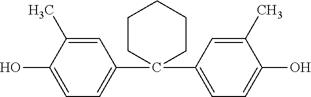 [SMILES: Cc1cc(C2(c3ccc(O)c(C)c3)CCCCC2)ccc1O]

which is also known as 1,1-bis(4-hydroxy-3-methylphenyl)cyclohexane.

Referring to Formula (1), in some aspects, R¹ may preferably be derived from a bisphenol of formula (3)

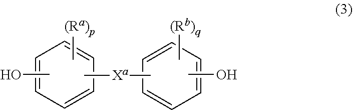

wherein R^{a} and R^{b} are each independently a halogen, C₁₋₁₂ alkoxy, or C₁₋₁₂ alkyl, and p and q are each independently integers of 0 to 4. It will be understood that when p or q is less than 4, the valence of each carbon of the ring is filled by hydrogen. Also in formula (3), X^{a} is a bridging group connecting the two hydroxy-substituted aromatic groups, where the bridging group and the hydroxy substituent of each C₆ arylene group are disposed ortho, meta, or para (preferably para) to each other on the C₆ arylene group. In an aspect, the bridging group X^{a} is single bond, —O—, —S—, —S(O)—, —S(O)₂—, —C(O)—, or a C₁₋₆₀ organic group. The organic bridging group may be cyclic or acyclic, aromatic or non-aromatic, and may further comprise heteroatoms such as halogens, oxygen, nitrogen, sulfur, silicon, or phosphorous. The C₁₋₆₀ organic group may be disposed such that the C₆ arylene groups connected thereto are each connected to a common alkylidene carbon or to different carbons of the C₁₋₆₀ organic bridging group. In an aspect, p and q is each 1, and R^{a} and R^{b} are each a C₁₋₃ alkyl group, preferably methyl, disposed meta to the hydroxy group on each arylene group.

In an aspect, X^{a} is a C₃₋₁₈ cycloalkylidene, a C₁₋₂₅ alkylidene of formula —C(R^{c})(R^{d})—wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{e})—wherein R^{e} is a divalent C₁₋₁₂ hydrocarbon group. Groups of these types include methylene, cyclohexylmethylidene, ethylidene, neopentylidene, and isopropylidene, as well as 2-[2.2.1]-bicycloheptylidene, cyclohexylidene, 3,3-dimethyl-5-methylcyclohexylidene, cyclopentylidene, cyclododecylidene, and adamantylidene.

In another aspect, X^{a} is a C₁₋₁₈ alkylene, a C₃₋₁₈ cycloalkylene, a fused C₆₋₁₈ cycloalkylene, or a group of the formula—J¹—G—J²—wherein J¹ and J² are the same or different C₁₋₆ alkylene and G is a C₃₋₁₂ cycloalkylidene or a C₆₋₁₆ arylene.

For example, X^{a} may be a substituted C₃₋₁₈ cycloalkylidene of formula (4)

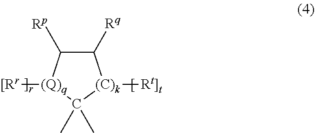

wherein R^{r}, R^{p}, R^{q}, and R^{t} are each independently hydrogen, halogen, oxygen, or C₁₋₁₂ hydrocarbon groups; Q is a direct bond, a carbon, or a divalent oxygen, sulfur, or —N(Z)— where Z is hydrogen, halogen, hydroxy, C₁₋₁₂ alkyl, C₁₋₁₂ alkoxy, C₆₋₁₂ aryl, or C₁₋₁₂ acyl; r is 0 to 2, t is 1 or 2, q is 0 or 1, and k is 0 to 3, with the proviso that at least two of R^{r}, R^{p}, R^{q}, and R^{t} taken together are a fused cycloaliphatic, aromatic, or heteroaromatic ring. It will be understood that where the fused ring is aromatic, the ring as shown in formula (4) will have an unsaturated carbon-carbon linkage where the ring is fused. When k is one and q is 0, the ring as shown in formula (4) contains 4 carbon atoms, when k is 2, the ring as shown in formula (4) contains 5 carbon atoms, and when k is 3, the ring contains 6 carbon atoms. In an aspect, two adjacent groups (e.g., R^{q} and R^{t} taken together) form an aromatic group, and in another aspect, R^{q} and R^{t} taken together form one aromatic group and R and RP taken together form a second aromatic group. When R^{q} and R^{t} taken together form an aromatic group, RP may be a double-bonded oxygen atom, i.e., a ketone, or Q may be —N(Z)— wherein Z is phenyl.

Bisphenols wherein X^{a} is a cycloalkylidene of formula (4) may be used in the manufacture of polycarbonates containing phthalimidine carbonate units of formula (1a)

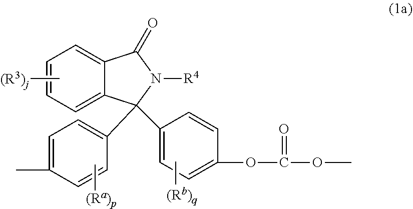

wherein R^{a}, R^{b}, p, and q are as in formula (3), R³ is each independently a C₁₋₆ alkyl, j is 0 to 4, and R₄ is hydrogen, C₁₋₆ alkyl, or a substituted or unsubstituted phenyl, for example a phenyl substituted with up to five C₁₋₆ alkyls. For example, the phthalimidine carbonate units are of formula (1b)

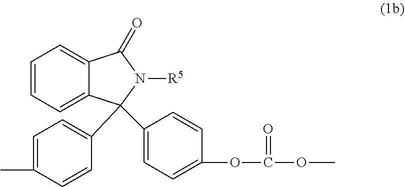

wherein R⁵ is hydrogen, phenyl optionally substituted with up to five 5 C₁₋₆ alkyls, or C₁₋₄ alkyl. In an aspect in formula (1b), R⁵ is hydrogen, methyl, or phenyl, preferably phenyl. Carbonate units (1b) wherein R⁵ is phenyl may be derived from 2-phenyl-3,3′-bis(4-hydroxy phenyl) phthalimidine (also known as 3,3-bis(4-hydroxyphenyl)-2-phenylisoindolin-1-one, or N-phenyl phenolphthalein bisphenol).

Other bisphenol carbonate repeating units of this type are the isatin carbonate units of formula (1c) and (1d)

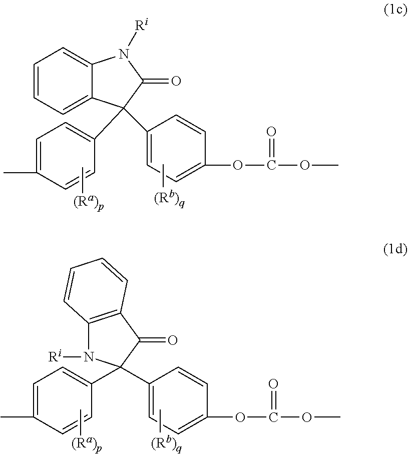

wherein R^{a} and R^{b} are each independently a halogen, C₁₋₁₂ alkoxy, or C₁₋₁₂ alkyl, p and q are each independently 0 to 4, and R¹ is C₁₋₁₂ alkyl, phenyl optionally substituted with 1 to 5 C₁₋₁₀ alkyl, or benzyl optionally substituted with 1 to 5 C₁₋₁₀ alkyl. In an aspect, R^{a} and R^{b} are each methyl, p and q are each independently 0 or 1, and R¹ is C₁₋₄ alkyl or phenyl.

Examples of other bisphenol carbonate units derived from bisphenol (3) wherein X^{a} is a substituted or unsubstituted C₃₋₁₈ cycloalkylidene include adamantyl units of formula (1f) and fluorenyl units of formula (1g)

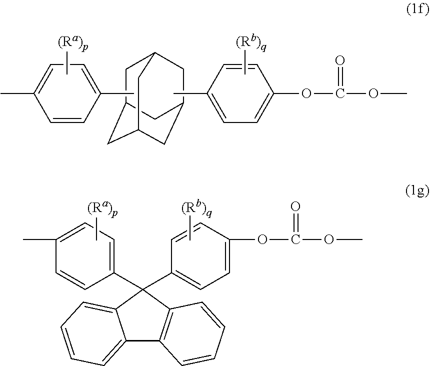

wherein R^{a} and Rb are each independently C₁₋₁₂ alkyl, and p and q are each independently 1 to 4. In a specific aspect, at least one of each of R^{a} and R^{b} are disposed meta to the cycloalkylidene bridging group. In an aspect, R^{a} and R^{b} are each independently C₁₋₃ alkyl, and p and q are each 0 or 1; preferably, R^{a}, R^{b} are each methyl, p and q are each 0 or 1, and when p and q are 1, the methyl group is disposed meta to the cycloalkylidene bridging group. Carbonates containing units (1a) to (1g) are useful for making polycarbonates with high glass transition temperatures (Tg) and high heat distortion temperatures.

In addition to the copolycarbonate including repeating units derived from a cyclohexylidene-bridged bisphenol, the polycarbonate compositions include an auxiliary polycarbonate. The copolycarbonate including repeating units derived from a cyclohexylidene-bridged bisphenol may be present from 50 to 99 wt % and the auxiliary polycarbonate may be present from 1 to 50 wt %, based on the total weight of the composition. Within those ranges, the copolycarbonate including repeating units derived from a cyclohexylidene-bridged bisphenol may be present from 55 to 95 wt % and the auxiliary polycarbonate may be present from 5 to 45 wt %, based on the total weight of the composition.

The auxiliary polycarbonate is different from the copolycarbonate including repeating units derived from a cyclohexylidene-bridged bisphenol and may include bisphenol carbonate units derived from of bisphenols (3) wherein X^{a} is an isophorylidene-bridged bisphenol of formula (1e), wherein t is 3.

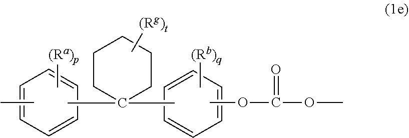

In some aspects, R^{a} and R^{b} are each independently C₁₋₁₂ alkyl, R^{g} is C₁₋₁₂ alkyl, p and q are each independently 0 to 4, and t is 3 to 10. In a specific aspect, at least one of each of R^{a} and R^{b} are disposed meta to the cyclohexylidene bridging group. In an aspect, R^{a} and R^{b} are each independently C₁₋₄ alkyl, R^{g} is C₁₋₄ alkyl, p and q are each 0 or 1, and t is 3 to 5. In some aspects, the copolycarbonate derived from an isophorylidene-bridged bisphenol includes repeating units derived from bisphenol A.

The isophorylidene-bridged bisphenol may have the following formula

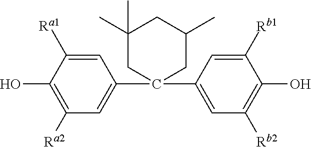

wherein R^{a1}, R^{a2}, R^{b1}, and R^{b2} are each independently hydrogen or methyl. In some aspects, R^{a1}, R^{a2}, R^{b1}, and R^{b2} are all hydrogen.

Other useful dihydroxy compounds of the formula HO—R¹—OH include aromatic dihydroxy compounds of formula (6)

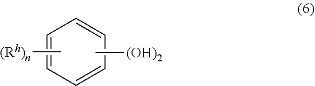

wherein each R^{h} is independently a halogen atom, C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4. The halogen is usually bromine.

Some illustrative examples of specific dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl) adamantane, alpha, alpha′-bis(4-hydroxyphenyl)toluene, bis(4-hydroxyphenyl) acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or a combination thereof.

Specific examples of bisphenol compounds of formula (3) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-2-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine, and 1,1-bis(4-hydroxy-3-methylphenyl)cyclohexane. A combination may also be used.

In a specific aspect, the copolycarbonate including repeating units derived from a cyclohexylidene-bridged bisphenol includes repeating units derived from bisphenol A, in which each of A¹ and A² is p-phenylene and Y¹ is isopropylidene in formula (3). The mole ratio of cyclohexylidene-bridged bisphenol units to other bisphenol units of Formula (3) (e.g., BPA) in the copolycarbonate can range from 5:95 to 95:5, 85:15 to 15:85, or 55:45 to 45:55. In some aspects, the polycarbonate comprises from 45 to 55 mole % of units derived from 1,1-bis(4-hydroxy-3-methylphenyl)cyclohexane. In certain aspects, the copolycarbonate comprises from 45 to 55 mole % of units derived from 1,1-bis(4-hydroxy-3-methylphenyl)cyclohexane and from 45 to 55 mole % of units derived from BPA.

The copolycarbonate including repeating units derived from a cyclohexylidene-bridged bisphenol may be present from 50-90 wt %, based on the total weight of the composition. Within this range the copolycarbonate including repeating units derived from a cyclohexylidene-bridged bisphenol may be present from 55 −85 wt %, or 60-80 wt %, based on the total weight of the composition.

Polycarbonates may be manufactured by processes such as interfacial polymerization and melt polymerization, which are known, and are described, for example, in WO 2013/175448 A1 and WO 2014/072923 A1. An end-capping agent (also referred to as a chain stopper agent or chain terminating agent) may be included during polymerization to provide end groups, for example monocyclic phenols such as phenol, p-cyanophenol, and C₁₋₂₂ alkyl-substituted phenols such as p-cumyl-phenol, resorcinol monobenzoate, and p- and tertiary-butyl phenol, monoethers of diphenols, such as p-methoxyphenol, monoesters of diphenols such as resorcinol monobenzoate, functionalized chlorides of aliphatic monocarboxylic acids such as acryloyl chloride and methacryoyl chloride, and mono-chloroformates such as phenyl chloroformate, alkyl-substituted phenyl chloroformates, p-cumyl phenyl chloroformate, and toluene chloroformate. Combinations of different end groups may be used.

Exemplary carbonate precursors include a carbonyl halide such as carbonyl bromide or carbonyl chloride (phosgene) a bishaloformate of a dihydroxy compound (e.g., the bischloroformate of bisphenol A, hydroquinone ethylene glycol, neopentyl glycol, or the like), and diaryl carbonates. A combination thereof can also be used. The diaryl carbonate ester can be diphenyl carbonate, or an activated diphenyl carbonate having electron-withdrawing substituents on the each aryl, such as bis(4-nitrophenyl)carbonate, bis(2-chlorophenyl)carbonate, bis(4-chlorophenyl)carbonate, bis(methyl salicyl)carbonate, bis(4-methylcarboxylphenyl) carbonate, bis(2-acetylphenyl) carboxylate, bis(4-acetylphenyl) carboxylate, or a combination thereof.

The polycarbonates may have an intrinsic viscosity, as determined in chloroform at 25° C., of 0.3 to 1.5 deciliters per gram (dl/gm), preferably 0.45 to 1.0 dl/gm. The polycarbonates may have a weight average molecular weight (Mw) of 10,000 to 200,000 Daltons, preferably 20,000 to 100,000 Daltons, as measured by gel permeation chromatography (GPC), using a crosslinked styrene-divinylbenzene column and calibrated to bisphenol A homopolycarbonate references. GPC samples are prepared at a concentration of 1 mg per ml, and are eluted at a flow rate of 1.5 ml per minute.

In addition to the copolycarbonate including repeating units derived from a cyclohexylidene-bridged bisphenol, the compositions include one or more auxiliary polycarbonates. The auxiliary polycarbonate(s) may be present from 10-50 wt %, based on the total weight of the composition. Within this range the auxiliary polycarbonate may be present from 15-45 wt %, or 20-40 wt %, based on the total weight of the composition.

The auxiliary polycarbonate may include a branched homopolycarbonate.

Branched polycarbonate blocks may be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. Combinations comprising linear polycarbonates and branched polycarbonates may be used.

In some aspects, a particular type of branching agent is used to create branched polycarbonate materials. These branched polycarbonate materials have statistically more than two end groups. The branching agent is added in an amount (relative to the bisphenol monomer) that is sufficient to achieve the desired branching content, that is, more than two end groups. The molecular weight of the polymer may become very high upon addition of the branching agent, and to avoid excess viscosity during polymerization, an increased amount of a chain stopper agent may be used, relative to the amount used when the particular branching agent is not present. The amount of chain stopper used is generally above 5 mole percent and less than 20 mole percent compared to the bisphenol monomer.

Such branching agents include aromatic triacyl halides, for example triacyl chlorides of formula (20)

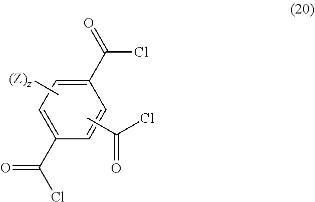

wherein Z is a halogen, C₁₋₃ alkyl, C₁₋₃ alkoxy, C₇₋₁₂ arylalkylene, C₇₋₁₂ alkylarylene, or nitro, and z is 0 to 3; a tri-substituted phenol of formula (21)

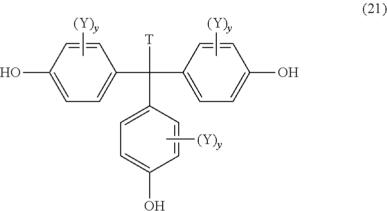

wherein T is a C₁₋₂₀ alkyl, C₁₋₂₀ alkoxy, C₇₋₁₂ arylalkyl, or C₇₋₁₂ alkylaryl, Y is a halogen, C₁₋₃ alkyl, C₁₋₃ alkoxy, C₇₋₁₂ arylalkyl, C₇₋₁₂ alkylaryl, or nitro, s is 0 to 4; or a compound of formula (22) (isatin-bis-phenol).

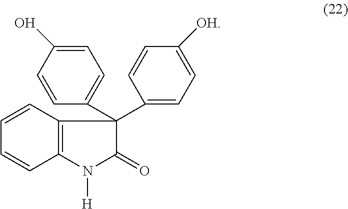 [SMILES: O=C1Nc2ccccc2C1(c1ccc(O)cc1)c1ccc(O)cc1]

Examples of specific branching agents that are particularly effective in the compositions include trimellitic trichloride (TMTC), tris-p-hydroxyphenylethane (THPE), and isatin-bis-phenol.

The amount of the branching agents used in the manufacture of the polymer will depend on a number of considerations, for example the type of R¹ groups, the amount of chain stopper, e.g., cyanophenol, and the desired molecular weight of the polycarbonate. In general, the amount of branching agent is effective to provide 0.1 to 10 branching units per 100 R¹ units, preferably 0.5 to 8 branching units per 100 R¹ units, and more preferably 0.75 to 5 branching units per 100 R¹ units. For branching agents having formula (20), the branching agent is present in an amount to provide 0.1 to 10 triester branching units per 100 R¹ units, preferably 0.5 to 8, and more preferably 0.75 to 5 triester branching units per 100 R¹ units. For branching agents having formula (21), the branching agent is present in an amount effective to provide 0.1 to 10 triphenyl carbonate branching units per 100 R¹ units, preferably 0.5 to 8, and more preferably 2.5 to 3.5 triphenylcarbonate units per 100 R¹ units. In some aspects, a combination of two or more branching agents may be used. Alternatively, the branching agents may be added at a level of 0.05 to 2.0 wt %. Within this range, the branching agents may be added at a level of 0.05 to 1.5 wt %, 0.05 to 1.0 wt %, or 0.05 to 0.5 wt %.

In some aspects, the branched polycarbonate can include greater than or equal to 0.1 mol %, or greater than or equal to 0.2 mol %, or greater than or equal to 0.3 mol % branching. Within these ranges, the branched polycarbonate can include less than 5 mol %, or less than 4 mol %, or less than 3 mol %, or less than 2 mol %, or less than less than 1 mol %, or less than 0.5 mole % branching.

In some aspects, the branched polycarbonate is present in an amount effective to provide 0.1 to 2 wt %, 0.1 to 1.5 wt %, 0.1 to 1.0 wt %, or 0.1 to 0.5 wt % branching to the total composition.

An end-capping agent (also referred to as a chain stopper agent or chain terminating agent) may be included during polymerization for both branched and unbranched polycarbonates to provide end groups. The end-capping agent (and thus end groups) are selected based on the desired properties of the polycarbonates. Exemplary end-capping agents are exemplified by monocyclic phenols such as phenol and C₁₋₂₂ alkyl-substituted phenols such as p-cumyl-phenol, resorcinol monobenzoate, and p- and tertiary-butyl phenol, monoethers of diphenols, such as p-methoxyphenol, and alkyl-substituted phenols with branched chain alkyl substituents having 8 to 9 carbon atoms, 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, mono-carboxylic acid chlorides such as benzoyl chloride, C₁₋₂₂ alkyl-substituted benzoyl chloride, toluoyl chloride, bromobenzoyl chloride, cinnamoyl chloride, and 4-nadimidobenzoyl chloride, polycyclic, mono-carboxylic acid chlorides such as trimellitic anhydride chloride, and naphthoyl chloride, functionalized chlorides of aliphatic monocarboxylic acids, such as acryloyl chloride and methacryoyl chloride, and mono-chloroformates such as phenyl chloroformate, alkyl-substituted phenyl chloroformates, p-cumyl phenyl chloroformate, and toluene chloroformate. Combinations of different end groups may be used.

“Polycarbonates” include homopolycarbonates (wherein each R¹ in the polymer is the same), copolymers comprising different R¹ moieties in the carbonate (“copolycarbonates”), and copolymers comprising carbonate units and other types of polymer units, such as ester units or siloxane units.

The auxiliary polycarbonate may include a specific type of copolymer, such as a poly(ester-carbonate), also known as a polyester-polycarbonate. Such copolymers further contain, in addition to recurring carbonate units of formula (1), repeating units of formula (7)

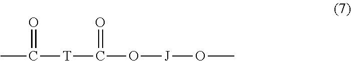

wherein J is a divalent group derived from a dihydroxy compound (including a reactive derivative thereof), and may be, for example, a C₁₋₁₀ alkylene, a C₆₋₂₀ cycloalkylene, a C₅₋₂₀ arylene, or a polyoxyalkylene in which the alkylene groups contain 2 to 6 carbon atoms, preferably 2, 3, or 4 carbon atoms; and T is a divalent group derived from a dicarboxylic acid (including a reactive derivative thereof), and may be, for example, a C₂₋₂₀ alkylene, a C₅₋₂₀ cycloalkylene, or a C₆₋₂₀ arylene. Copolyesters containing a combination of different T or J groups may be used. The polyester units may be branched or linear.

In an aspect, J is a C₂₋₃₀ alkylene group having a straight chain, branched chain, or cyclic (including polycyclic) structure, for example ethylene, n-propylene, i-proplyene, 1,4-butylene, 1,4-cyclohexylene, or 1,4-methylenecyclohexane. In another aspect, J is derived from a bisphenol of formula (3), e.g., bisphenol A. In another aspect, J is derived from an aromatic dihydroxy compound of formula (6), e.g, resorcinol.

Aromatic dicarboxylic acids that may be used to prepare the polyester units include isophthalic or terephthalic acid, 1,2-di(p-carboxyphenyl)ethane, 4,4′-dicarboxydiphenyl ether, 4,4′-bisbenzoic acid, or a combination thereof. Acids containing fused rings may also be present, such as in 1,4-, 1,5-, or 2,6-naphthalenedicarboxylic acids. Specific dicarboxylic acids include terephthalic acid, isophthalic acid, naphthalene dicarboxylic acid, 1,4-cyclohexane dicarboxylic acid, or a combination thereof. A specific dicarboxylic acid comprises a combination of isophthalic acid and terephthalic acid wherein the weight ratio of isophthalic acid to terephthalic acid is 91:9 to 2:98.

Specific ester units include ethylene terephthalate, n-propylene terephthalate, n-butylene terephthalate, 1,4-cyclohexanedimethylene terephthalate, and ester units derived from isophthalic acid, terephthalic acid, and resorcinol (ITR)). The molar ratio of ester units to carbonate units in the copolymers may vary broadly, for example 1:99 to 99:1, preferably 10:90 to 90:10, more preferably 25:75 to 75:25, or 2:98 to 15:85, depending on the desired properties of the final composition. Specific poly(ester-carbonate)s are those including bisphenol A carbonate units and isophthalate-terephthalate-bisphenol A ester units, also commonly referred to as poly(carbonate-ester)s and poly(phthalate-carbonate)s, depending on the molar ratio of carbonate units and ester units.

The auxiliary polycarbonate of the polycarbonate compositions may include a specific example of a poly(ester-carbonate), which is a poly(aliphatic ester-carbonate derived from a linear C₆₋₂₀ aliphatic dicarboxylic acid (which includes a reactive derivative thereof), specifically a linear C₆₋₁₂ aliphatic dicarboxylic acid (which includes a reactive derivative thereof). Specific dicarboxylic acids include n-hexanedioic acid (adipic acid), n-decanedioic acid (sebacic acid), and alpha, omega-C₁₂ dicarboxylic acids such as dodecanedioic acid (DDDA). A specific poly(aliphatic ester)-polycarbonate is of formula (8):

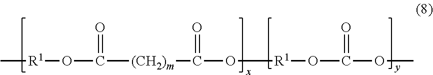

wherein each R¹ may be the same or different, and is as described in formula (1), m is 4 to 18, preferably 4 to 10, and the average molar ratio of ester units to carbonate units x:y is 99:1 to 1:99, including 13:87 to 2:98, or 9:91 to 2:98, or 8:92 to 2:98. In a specific aspect, the poly(aliphatic ester)-polycarbonate copolymer comprises bisphenol A sebacate ester units and bisphenol A carbonate units, having, for example an average molar ratio of x:y of 2:98 to 8:92, for example 6:94.

The poly(aliphatic ester-carbonate) may have a weight average molecular weight of 15,000 to 40,000 Dalton (Da), including 20,000 to 38,000 Da (measured by GPC based on BPA polycarbonate standards).

In the manufacture of poly(ester-carbonate)s by interfacial polymerization, rather than using the dicarboxylic acid or diol directly, the reactive derivatives of the diacid or diol, such as the corresponding acid halides, in particular the acid dichlorides and the acid dibromides may be used. Thus, for example instead of using isophthalic acid, terephthalic acid, or a combination thereof, isophthaloyl dichloride, terephthaloyl dichloride, or a combination thereof may be used.

In addition to the polycarbonates described above, combinations of the polycarbonate with other thermoplastic polymers, for example combinations of homopolycarbonates, copolycarbonates, and polycarbonate copolymers with polyesters, may be used. Useful polyesters include, for example, polyesters having repeating units of formula (7), which include poly(alkylene dicarboxylates), liquid crystalline polyesters, and polyester copolymers. The polyesters described herein are generally completely miscible with the polycarbonates when blended.

The polyesters may be obtained by interfacial polymerization or melt-process condensation as described above, by solution phase condensation, or by transesterification polymerization wherein, for example, a dialkyl ester such as dimethyl terephthalate may be transesterified with ethylene glycol using acid catalysis, to generate poly(ethylene terephthalate).

A branched polyester, in which a branching agent, for example, a glycol having three or more hydroxyl groups or a trifunctional or multifunctional carboxylic acid has been incorporated, may be used. Furthermore, it may be desirable to have various concentrations of acid and hydroxyl end groups on the polyester, depending on the ultimate end use of the composition.

Useful polyesters may include aromatic polyesters, poly(alkylene esters) including poly(alkylene arylates), and poly(cycloalkylene diesters). Aromatic polyesters may have a polyester structure according to formula (7), wherein J and T are each aromatic groups as described above. In an aspect, useful aromatic polyesters may include poly(isophthalate-terephthalate-resorcinol) esters, poly(isophthalate-terephthalate-bisphenol A) esters, poly[(isophthalate-terephthalate-resorcinol) ester-co-(isophthalate-terephthalate-bisphenol A)]ester, or a combination comprising at least one of these. Also contemplated are aromatic polyesters with a minor amount, e.g., 0.5 to 10 weight percent, based on the total weight of the polyester, of units derived from an aliphatic diacid or an aliphatic polyol to make copolyesters. Poly(alkylene arylates) may have a polyester structure according to formula (7), wherein T comprises groups derived from aromatic dicarboxylates, cycloaliphatic dicarboxylic acids, or derivatives thereof. Examples of preferably useful T groups include 1,2-, 1,3-, and 1,4-phenylene; 1,4- and 1,5-naphthylenes; cis- or trans-1,4-cyclohexylene; and the like. Preferably, where T is 1,4-phenylene, the poly(alkylene arylate) is a poly(alkylene terephthalate). In addition, for poly(alkylene arylate), preferably useful alkylene groups J include, for example, ethylene, 1,4-butylene, and bis-(alkylene-disubstituted cyclohexane) including cis- or trans-1,4-(cyclohexylene)dimethylene. Examples of poly(alkylene terephthalates) include poly(ethylene terephthalate) (PET), poly(1,4-butylene terephthalate) (PBT), and poly(n-propylene terephthalate) (PPT). Also useful are poly(alkylene naphthoates), such as poly(ethylene naphthanoate) (PEN), and poly(butylene naphthanoate) (PBN). A preferably useful poly(cycloalkylene diester) is poly(1,4-cyclohexanedimethylene terephthalate) (PCT). Combinations comprising at least one of the foregoing polyesters may also be used.

Copolymers comprising alkylene terephthalate repeating ester units with other ester groups may also be useful. Preferably useful ester units may include different alkylene terephthalate units, which may be present in the polymer chain as individual units, or as blocks of poly(alkylene terephthalates). Copolymers of this type include poly(cyclohexanedimethylene terephthalate)-co-poly(ethylene terephthalate), abbreviated as PETG where the polymer comprises greater than or equal to 50 mol % of poly(ethylene terephthalate), and abbreviated as PCTG where the polymer comprises greater than 50 mol % of poly(1,4-cyclohexanedimethylene terephthalate).

Poly(cycloalkylene diester)s may also include poly(alkylene cyclohexanedicarboxylate)s. Of these, the auxiliary polycarbonate may include a specific example is poly(1,4-cyclohexane-dimethanol-1,4-cyclohexanedicarboxylate) (PCCD), having recurring units of formula (9)

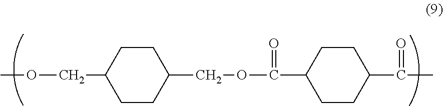

wherein, as described using formula (7), J is a 1,4-cyclohexanedimethylene group derived from 1,4-cyclohexanedimethanol, and T is a cyclohexane ring derived from cyclohexanedicarboxylate or a chemical equivalent thereof, and may comprise the cis-isomer, the trans-isomer, or a combination thereof.

The polycarbonates and polyesters may be used in a weight ratio of 1:99 to 99:1, preferably 10:90 to 90:10, and more preferably 30:70 to 70:30, depending on the function and properties desired.

The polycarbonate composition may further include a poly(carbonate-siloxane), also referred to in the art as a polycarbonate-polysiloxane copolymer. The polysiloxane blocks comprise repeating diorganosiloxane units as in formula (10)

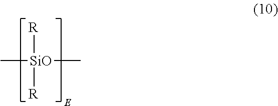

wherein each R is independently a C₁₋₁₃ monovalent organic group. For example, R may be a C₁₋₁₃ alkyl, C₁₋₁₃ alkoxy, C₂₋₁₃ alkenyl, C₂₋₁₃ alkenyloxy, C₃₋₆ cycloalkyl, C₃₋₆ cycloalkoxy, C₆₋₁₄ aryl, C₆₋₁₀ aryloxy, C₇₋₁₃ arylalkylene, C₇₋₁₃ arylalkylenoxy, C₇₋₁₃ alkylarylene, or C₇₋₁₃ alkylaryleneoxy. The foregoing groups may be fully or partially halogenated with fluorine, chlorine, bromine, or iodine, or a combination thereof. In an aspect, where a transparent poly(carbonate-siloxane) is desired, R is unsubstituted by halogen. Combinations of the foregoing R groups may be used in the same copolymer.

The value of E in formula (10) may vary widely depending on the type and relative amount of each component in the polycarbonate composition, the desired properties of the composition, and like considerations. Generally, E has an average value of 2 to 1,000, preferably 2 to 500, 2 to 200, or 2 to 125, 5 to 80, or 10 to 70. In an aspect, E has an average value of 10 to 80 or 10 to 40, and in still another aspect, E has an average value of 40 to 80, or 40 to 70. Where E is of a lower value, e.g., less than 40, it may be desirable to use a relatively larger amount of the poly(carbonate-siloxane) copolymer. Conversely, where E is of a higher value, e.g., greater than 40, a relatively lower amount of the poly(carbonate-siloxane) copolymer may be used. A combination of a first and a second (or more) poly(carbonate-siloxane) copolymers may be used, wherein the average value of E of the first copolymer is less than the average value of E of the second copolymer.

In an aspect, the polysiloxane blocks are of formula (11)

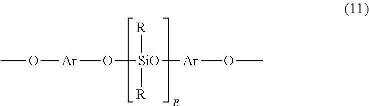

wherein E and R are as defined if formula (10); each R may be the same or different, and is as defined above; and Ar may be the same or different, and is a substituted or unsubstituted C₆₋₃₀ arylene, wherein the bonds are directly connected to an aromatic moiety. Ar groups in formula (11) may be derived from a C₆₋₃₀ dihydroxyarylene compound, for example a dihydroxyarylene compound of formula (3) or (6). Dihydroxyarylene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl)cyclohexane, bis(4-hydroxyphenyl sulfide), and 1,1-bis(4-hydroxy-t-butylphenyl) propane.

In another aspect, polysiloxane blocks are of formula (13)

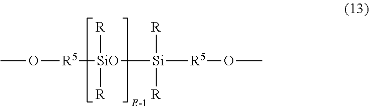

wherein R and E are as described above, and each R⁵ is independently a divalent C₁₋₃₀ organic group, and wherein the polymerized polysiloxane unit is the reaction residue of its corresponding dihydroxy compound. In a specific aspect, the polysiloxane blocks are of formula (14):

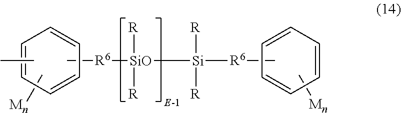

wherein R and E are as defined above. R⁶ in formula (14) is a divalent C₂₋₈ aliphatic group. Each M in formula (14) may be the same or different, and may be a halogen, cyano, nitro, C₁₋₈ alkylthio, C₁₋₈ alkyl, C₁₋₈ alkoxy, C₂₋₈ alkenyl, C₂₋₈ alkenyloxy, C₃₋₈ cycloalkyl, C₃₋₈ cycloalkoxy, C₆₋₁₀ aryl, C₆₋₁₀ aryloxy, C₇₋₁₂ aralkyl, C₇₋₁₂ aralkoxy, C₇₋₁₂ alkylaryl, or C₇₋₁₂ alkylaryloxy, wherein each n is independently 0, 1, 2, 3, or 4.

In an aspect, M is bromo or chloro, an alkyl such as methyl, ethyl, or propyl, an alkoxy such as methoxy, ethoxy, or propoxy, or an aryl such as phenyl, chlorophenyl, or tolyl; R⁶ is a dimethylene, trimethylene or tetramethylene; and R is a C₁₋₈ alkyl, haloalkyl such as trifluoropropyl, cyanoalkyl, or aryl such as phenyl, chlorophenyl or tolyl. In another aspect, R is methyl, or a combination of methyl and trifluoropropyl, or a combination of methyl and phenyl. In still another aspect, R is methyl, M is methoxy, n is one, and R⁶ is a divalent C₁₋₃ aliphatic group. Specific polysiloxane blocks are of the formula

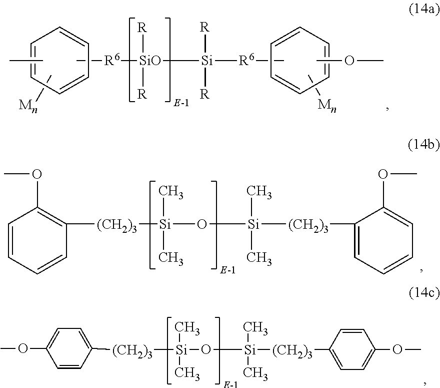

or a combination thereof, wherein E has an average value of 2 to 200, 2 to 125, 5 to 125, 5 to 100, 5 to 50, 20 to 80, or 5 to 20.

Blocks of formula (14) may be derived from the corresponding dihydroxy polysiloxane, which in turn may be prepared effecting a platinum-catalyzed addition between the siloxane hydride and an aliphatically unsaturated monohydric phenol uch as eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. The poly(carbonate-siloxane) copolymers may then be manufactured, for example, by the synthetic procedure of European Patent Application Publication No. 0 524 731 A1 of Hoover, page 5, Preparation 2.

Transparent poly(carbonate-siloxane) copolymers comprise carbonate units (1) derived from bisphenol A, and repeating siloxane units (14a), (14b), (14c), or a combination thereof (preferably of formula 14a), wherein E has an average value of 4 to 50, 4 to 15, preferably 5 to 15, more preferably 6 to 15, and still more preferably 7 to 10. The transparent copolymers may be manufactured using one or both of the tube reactor processes described in U.S. Patent Application No. 2004/0039145A1 or the process described in U.S. Pat. No. 6,723,864 may be used to synthesize the poly(carbonate-siloxane) copolymers.

The poly(carbonate-siloxane) copolymers may comprise 50 to 99 weight percent of carbonate units and 1 to 50 weight percent siloxane units. Within this range, the poly(carbonate-siloxane) copolymer may comprise 70 to 98 weight percent, more preferably 75 to 97 weight percent of carbonate units and 2 to 30 weight percent, more preferably 3 to 25 weight percent siloxane units.

In an aspect, a blend is used, in particular a blend of a bisphenol A homopolycarbonate and a poly(carbonate-siloxane) block copolymer of bisphenol A blocks and eugenol capped polydimethylsiloxane blocks, of the formula

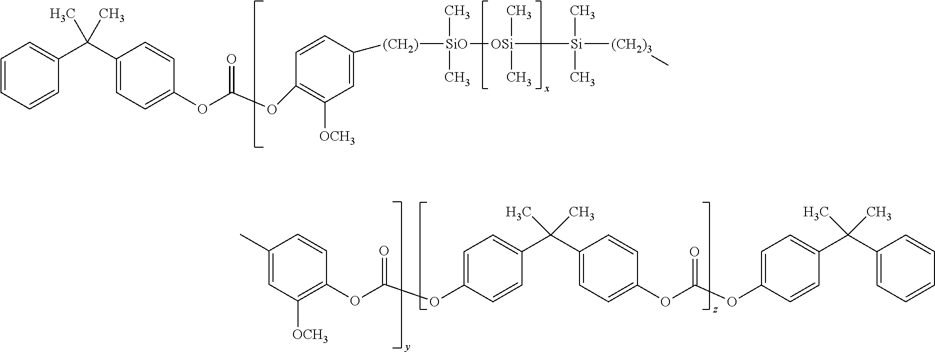

wherein x is 1 to 200, preferably 5 to 85, preferably 10 to 70, preferably 15 to 65, and more preferably 40 to 60; x is 1 to 500, or 10 to 200, and z is 1 to 1000, or 10 to 800. In an aspect, x is 1 to 200, y is 1 to 90 and z is 1 to 600, and in another aspect, x is 30 to 50, y is 10 to 30 and z is 45 to 600. The polysiloxane blocks may be randomly distributed or controlled distributed among the polycarbonate blocks.

The auxiliary polycarbonate may include a poly(carbonate siloxane) having a siloxane content of less than 20 wt % based on the total weight of the poly(carbonate-siloxane).

In an aspect, the poly(carbonate-siloxane) copolymer comprises 10 wt % or less, preferably 6 wt % or less, and more preferably 4 wt % or less, of the polysiloxane based on the total weight of the poly(carbonate-siloxane) copolymer, and are generally optically transparent. In another aspect, the poly(carbonate-siloxane) copolymer comprises 10 wt % or more, preferably 12 wt % or more, and more preferably 14 wt % or more, of the polysiloxane copolymer based on the total weight of the poly(carbonate-siloxane) copolymer, are generally optically opaque.

Poly(carbonate-siloxane)s may have a weight average molecular weight of 2,000 to 100,000 Daltons, preferably 5,000 to 50,000 Daltons as measured by gel permeation chromatography using a crosslinked styrene-divinyl benzene column, at a sample concentration of 1 milligram per milliliter, and as calibrated with polycarbonate standards.

The poly(carbonate-siloxane)s may have a melt volume flow rate, measured at 300° C./1.2 kg, of 1 to 50 cubic centimeters per 10 minutes (cc/10 min), preferably 2 to 30 cc/10 min. Combinations of the poly(carbonate-siloxane)s of different flow properties may be used to achieve the overall desired flow property.

The compositions may include a copolycarbonate comprising repeating units derived from a cyclohexylidene-bridged bisphenol and one auxiliary polycarbonate. In some aspects, the compositions include a cyclohexylidene-bridged bisphenol and a branched polycarbonate, wherein the branched polycarbonate comprises greater than or equal to 0.1 mol % branching. In some aspects, the compositions include a cyclohexylidene-bridged bisphenol and a poly(1,4-cyclohexanedimethylene terephthalate). In some aspects, the compositions include a cyclohexylidene-bridged bisphenol and a copolycarbonate comprising repeating units derived from an isophorylidene-bridged bisphenol.

The compositions may include a copolycarbonate comprising repeating units derived from a cyclohexylidene-bridged bisphenol and various combinations of auxiliary polycarbonates. 1) In some aspects, the compositions include a cyclohexylidene-bridged bisphenol and a combination of a branched polycarbonate and a poly(1,4-cyclohexanedimethylene terephthalate), wherein the branched polycarbonate comprises greater than or equal to 0.1 mol % branching. 2) In some aspects, the compositions include a cyclohexylidene-bridged bisphenol and a combination of a poly(1,4-cyclohexanedimethylene terephthalate) and a copolycarbonate comprising repeating units derived from an isophorylidene-bridged bisphenol, or a combination thereof 0.3) In some aspects, the compositions include a cyclohexylidene-bridged bisphenol and a copolycarbonate comprising repeating units derived from an isophorylidene-bridged bisphenol and a branched polycarbonate, wherein the branched polycarbonate comprises greater than or equal to 0.1 mol % branching.

Each of the foregoing compositions described above may further include one or more optional auxiliary polycarbonates. The foregoing compositions may include a poly(alkylene cyclohexanedicarboxylate). The foregoing compositions may include a poly(carbonate siloxane) having a siloxane content of less than 20 wt % based on the total weight of the poly(carbonate-siloxane). The foregoing compositions may include a poly(aliphatic ester-carbonate) comprising bisphenol A carbonate units and C₆₋₁₂ dicarboxy ester units. In some aspects, the foregoing compositions may include combinations of optional auxiliary polycarbonates. In some aspects, the foregoing compositions include a poly(alkylene cyclohexanedicarboxylate) and poly(carbonate siloxane) having a siloxane content of less than 20 wt % based on the total weight of the poly(carbonate-siloxane). In some aspects, the foregoing compositions include a poly(aliphatic ester-carbonate) comprising bisphenol A carbonate units and C₆₋₁₂ dicarboxy ester units and poly(carbonate siloxane) having a siloxane content of less than 20 wt % based on the total weight of the poly(carbonate-siloxane). In some aspects, the foregoing compositions include a poly(alkylene cyclohexanedicarboxylate) and a poly(aliphatic ester-carbonate) comprising bisphenol A carbonate units and C₆₋₁₂ dicarboxy ester units. In some aspects, the foregoing compositions include a poly(alkylene cyclohexanedicarboxylate), poly(carbonate siloxane) having a siloxane content of less than 20 wt % based on the total weight of the poly(carbonate-siloxane), and a poly(aliphatic ester-carbonate) comprising bisphenol A carbonate units and C₆₋₁₂ dicarboxy ester.

The polycarbonate compositions may include various additives ordinarily incorporated into polymer compositions of this type, with the proviso that the additive(s) are selected so as to not significantly adversely affect the desired properties of the polycarbonate composition, in particular the optical properties, for example the percent transmission. Such additives may be mixed at a suitable time during the mixing of the components for forming the composition. Additives include fillers, reinforcing agents, antioxidants, heat stabilizers, light stabilizers, ultraviolet (UV) light stabilizers, plasticizers, lubricants, mold release agents, antistatic agents, colorants such as such as titanium dioxide, carbon black, and organic dyes, surface effect additives, radiation stabilizers, flame retardants, and anti-drip agents. A combination of additives may be used, for example a combination of a heat stabilizer, mold release agent, and ultraviolet light stabilizer. In general, the additives are used in the amounts generally known to be effective. For example, the total amount of the additives (other than any impact modifier, filler, or reinforcing agents) may be 0.01 to 5 wt %, based on the total weight of the polycarbonate composition.

The polycarbonate compositions may be manufactured by various methods. For example, the powdered polycarbonates and optional components are first blended, optionally with fillers in a HENSCHEL-Mixer® high speed mixer. Other low shear processes, including but not limited to hand mixing, may also accomplish this blending. The blend is then fed into the throat of a twin-screw extruder via a hopper. Alternatively, at least one of the components may be incorporated into the composition by feeding directly into the extruder at the throat or downstream through a sidestuffer. Additives may also be compounded into a masterbatch with a desired polymeric polymer and fed into the extruder. The extruder is generally operated at a temperature higher than that necessary to cause the composition to flow. The extrudate is immediately quenched in a water bath and pelletized. The pellets so prepared may be one-fourth inch long or less as desired. Such pellets may be used for subsequent molding, shaping, or forming.

Transparent compositions may be produced by manipulation of the process used to manufacture the polycarbonate composition. One example of such a process to produce transparent polycarbonate compositions is described in U.S. Patent Application No. 2003/0032725.

The polycarbonate compositions can have a transparency of 89% or greater as measured using 2.5 mm plaques according to ASTM-D1003-00. The polycarbonate compositions can have a haze of 4% or less, 2% or less, 0.1 to 4%, 0.1 to 2%, or 0.1 to 1.5%, each as measured using 3.18 or 2.5 mm thick plaques according to ASTM-D1003-00.

When the auxiliary polycarbonate includes auxiliary polycarbonates including a branched homopolycarbonate; a poly(1,4-cyclohexanedimethylene terephthalate), a copolycarbonate comprising repeating units derived from an isophorylidene-bridged bisphenol, and optionally a poly(alkylene cyclohexanedicarboxylate), a poly(carbonate siloxane) having a siloxane content of less than 20 wt % based on the total weight of the poly(carbonate-siloxane), or a combination thereof, then the polycarbonate compositions can have a heat deformation temperature (HDT) of at least 127° C. at 0.45 MPa or at least 110° C. at 1.82 MPa as determined on one-eighth inch (3.18 mm) bars per ASTM D648.

When the auxiliary polycarbonate comprises a poly(aliphatic ester-carbonate), then a molded sample of the polycarbonate compositions can have a heat deformation temperature (HDT) of at least 111° C. at 0.45 MPa or at least 98° C. at 1.82 MPa as determined on one-eighth inch (3.18 mm) bars per ASTM D648.

Shaped, formed, or molded articles comprising the polycarbonate compositions are also provided. The polycarbonate compositions can be molded into useful shaped articles by a variety of methods, such as injection molding, extrusion, rotational molding, blow molding and thermoforming. Some example of articles include computer and business machine housings such as housings for monitors, handheld electronic device housings such as housings for cell phones, electrical connectors, and components of lighting fixtures, ornaments, home appliances, roofs, greenhouses, sunrooms, swimming pool enclosures, and the like. Some examples of articles include computer and business machine housings such as housings for monitors, handheld electronic device housings such as housings for cell phones, electrical connectors, and components of lighting fixtures, ornaments, home appliances, and the like. In addition, the compositions can be used in healthcare applications, such as for components used in healthcare, such as, for example hand-held devices and computer monitors, and in particular touch-screens for such devices. The articles can include automotive components, such as, for example, instrument panels, consoles, interior trim parts, door panels, door grips (e.g. interior), shift boots, and dashboards.

This disclosure is further illustrated by the following examples, which are non-limiting.

### EXAMPLES

The following components are used in the examples. Unless specifically indicated otherwise, the amount of each component is in wt %, based on the total weight of the composition.

The materials shown in Table 1 were used.

TABLE 1

| | | |
|---|---|---|
| PC-1 | Polycarbonate (50 mol % 1,1-bis(4-hydroxy-3-methylphenyl)cyclohexane-co- | SABIC |
| | 50 mol % bisphenol A), Mw = 22,000-35,000 g/mol as per GPC using | |
| | polystyrene standards and calculated for polycarbonate | |
| PC-2 | Poly(bisphenol A carbonate-resorcinol phthalate) having 73-77 mol % | SABIC |
| | bisphenol A carbonate linkages, 5-7 mol % resorcinol carbonate linkages, and | |
| | 18-20 mol % resorcinol phthalate linkages with an isophthalate:terephthalate | |
| | ratio of 1:1; Tg = 140-145° C., Mw = 29,000-31,000 g/mol as per GPC using | |
| | polystyrene standards and calculated for polycarbonate | |
| PC-3 | Poly(bisphenol A carbonate-resorcinol phthalate) having 8-12 mol % bisphenol | SABIC |
| | A carbonate linkages, 8-12 mol % resorcinol carbonate linkages, 78-82 mol % | |
| | resorcinol phthalate ester linkages with an isophthalate:terephthalate ratio of | |
| | 1:1; Tg = 130-142° C., Mw = 20,000-22,000 g/mol as per GPC using | |
| | polystyrene standards and calculated for polycarbonate | |
| PC-4 | Branched bisphenol A polycarbonate containing about 3 mole % of THPE as | SABIC |
| | branching agent with 4-hydroxy benzonitrile as endcap, having a molecular | |
| | weight (Mw) of 26,200-31,200 g/mole, as determined by GPC using | |
| | polystyrene standards and calculated for polycarbonate, produced by interfacial | |
| | polymerization and end capped with p-cumyl phenol | |
| PC-5 | Sebacic acid-bisphenol A copolymer, 8.3 mol % sebacic acid, p-cumylphenol | SABIC |
| | endcap, MFR = 6.5 g/10 min based on ASTM D1238, Mw = 35,000-37,000, as | |
| | determined via GPC using polystyrene standards and calculated for | |
| | polycarbonate | |
| PC-6 | Poly(bisphenol A carbonate-bisphenol A phthalate) having 19-21 wt % | SABIC |
| | bisphenol A carbonate units and 79-81 wt % bisphenol A phthalate groups with | |
| | an isophthalate:terephthalate ratio of 93:7; Mw = 27,000-29,000 as per GPC | |
| | using polystyrene standards and calculated for polycarbonate, para-cumyl | |
| | phenol (PCP) end-capped | |
| PC-7 | Poly (N-phenylphenolphthaleinylbisphenol, 2,2-bis(4-hydro) carbonate -co- | SABIC |
| | bisphenol A carbonate), 35 mol % PPPBP units, Mw = 25,000 g/mol | |
| | determined via GPC using polystyrene standards, made by interfacial | |
| | polymerization, PCP end-capped, PDI = 2-3 | |
| PC-8 | Poly(bisphenol A/resorcinol carbonate-resorcinol phthalate-dimethyl siloxane) | SABIC |
| | having 8-12 mol % bisphenol A carbonate linkages, 8-12 mol % resorcinol | |
| | carbonate linkages, 83 mol % resorcinol phthalate ester linkages with an | |
| | isophthalate:terephthalate ratio of 1:1, and 0.8-1.2 wt % of a eugenol-linked | |
| | D10 dimethylsiloxane; produced via interfacial polymerization, para-cumyl | |
| | phenol endcapped; Mw = 22,500-26,500 g/mol as determined by GPC using | |
| | polystyrene standards and calculated for polycarbonate | |
| PC-9 | Branched bisphenol A homopolymer, containing 0.4 mole % 1,1,1-tris(4- | SABIC |
| | hydroxyphenyl)ethane (THPE) branching agent, having a molecular weight | |
| | (Mw) of 38,000-39,300 g/mole, as determined by GPC using polystyrene | |
| | standards and calculated for polycarbonate, produced by interfacial | |
| | polymerization and endcapped with p-cumylphenol | |
| PC-10 | Poly(bisphenol A carbonate-resorcinol phthalate) having 73-77 mol % | SABIC |
| | bisphenol A carbonate linkages, 5-7 mol % resorcinol carbonate linkages, and | |
| | 18-20 mol % resorcinol phthalate linkages with an isophthalate:terephthalate | |
| | ratio of 1:1; Tg = 140-145° C., Mw = 29,000-31,000 g/mol as per GPC using | |
| | polystyrene standards and calculated for polycarbonate | |
| PC-Si-1 | PDMS (polydimethylsiloxane)-Bisphenol A polycarbonate copolymer, 20 wt % | SABIC |
| | siloxane, average PDMS block length 45 units (D45), Mw 29,000-31,000 | |
| | g/mol as determined by GPC using polycarbonate standards, eugenol end- | |
| | capped | |
| PC-Si-2 | PDMS (polydimethylsiloxane)-Bisphenol A polycarbonate copolymer, 6 wt % | SABIC |
| | siloxane, average PDMS block length 45 units (D45), Mw 22,000-24,000 | |
| | g/mol as determined by GPC using polycarbonate standards, eugenol end- | |
| | capped | |
| PC-11 | Poly(1,4-cyclohexanedimethylene-1,4-cyclohexane dicarboxylate), intrinsic | SABIC |
| | viscosity 0.96 | |
| PC-12 | Poly(80 mol % 1,4-cyclohexane dimethylene terephthalate co-20 mol % | SABIC |
| | ethylene terephthalate), Mw = 70,000 g/mol determined via GPC using | |
| | polystyrene standards and calculated for polycarbonate | |
| PC-13 | Poly(1,4-cyclohexanedimethylene terephthalate), Mw = 70,000 g/mol | SABIC |
| | determined via GPC using polystyrene standards and calculated for | |
| | polycarbonate | |
| PC-14 | Polybutylene terephthalate, CAS Reg. No. 26062-94-2, with an intrinsic | SABIC |
| | viscosity of 0.6-0.7 dl/g | |
| PC-15 | Poly(isophorylidene bisphenol carbonate-bisphenol A carbonate) | COVESTRO |
| UVA-1 | 2-[2-hydroxy-3,5-di-(1,1-dimethylbenyl)]-2H-benzotriazol, available as UVA | BASF Corp. |
| | 234 | |
| UVA-2 | 2-(2H-benzotriazol-2-y1)-4-(1,1,3,3-tetramethylbutyl)phenol | CYTEC |
| PHOS | Tetrakis(2,4-di-tert-butylphenyl)[1,1-biphenyl]-4,4′diylbisphosphonite | Clariant |
| | (“PEPQ”) | |
| PETS | Pentaerythritol tetrastearate, >90% esterified | Faci |
| MZP | Mono zinc phosphate | Budenheim |
| TBPP | Tris(2,4-di-tert-butylphenyl) phosphite, CAS Reg. No. 31570-04-4; available | BASF Corp. |
| | as IRGAFOS 168 | |

The testing samples were prepared as described below and the following test methods were used.

Typical compounding procedures are described as follows: The various formulations were prepared by direct dry-blending of the raw materials and homogenized with a paint shaker prior to compounding. The formulations were compounded on a 25 mm Werner Pfleiderer ZSK co-rotating twin-screw extruder. A typical extrusion profile is listed in Table 2.

TABLE 2

| Parameters | Unit | 25 mm ZSK |
|---|---|---|
| Die | — | 2 holes |
| Feed temperature | | 38 |
| Zone 1 temp. | ° C. | 177 |
| Zone 2-8 temp. | | 240 |
| Die temperature | ° C. | 288 |
| Screw speed | rpm | 450 |
| Throughput | kg/h | 20 |
| Vacuum 1 | bar | 0.75 |

An Engel 90 molding machine was used to mold the test parts for standard physical property testing. (for parameters see Table 3).

TABLE 3

| Parameters | Unit | |
|---|---|---|
| Pre-drying time | h | 4 |
| Pre-drying temp. | ° C. | 120 |
| Hopper temp. | ° C. | 70 |
| Zone 1 temp. | ° C. | 270 |
| Zone 2 temp. | ° C. | 290 |
| Zone 3 temp. | ° C. | 305 |
| Nozzle temp. | ° C. | 300 |
| Mold temperature | ° C. | 80 |
| Screw speed | rpm | 100 |
| Back pressure | bar | 3.45 |
| Injection time | s | 2 |
| Approx. cycle time | s | 35 |

Sample preparation and testing methods are described in Table 4.

TABLE 4

| Property | Standard | Conditions | | Specimen |
|---|---|---|---|---|
| Melt volume | ASTM | 300° C., 1.2 | | Pellets |
| rate (MVR) | D1238-04 | kg, 6 min | | |
| High shear | ISO11443 | 300° | C. | Pellets |
| viscosity | | | | |
| Heat deformation | ASTM D648 | 0.45 MPa, 1.82 MPa | | 3.18 mm bars |
| temperature | | | | |
| (HDT) | | | | |
| Ductility | ASTM 256 | 23° | C. | 3.18 mm bars |
| Notched Izod | ASTM 256 | 23° | C. | 3.18 mm bars |
| Impact Strength | | | | |
| Tensile properties | ASTM D638 | 23° C., 50 mm/min | | 3.18 mm bars |
| Transmission | ASTM | 23° | C. | 2.5 mm |
| | D1003 | | | plaques |
| Haze | ASTM | 23° | C. | 2.5 mm |
| | D1003 | | | plaques |

### Examples 1-9

Table 6 shows the compositions and properties for the following comparative examples and examples. Comparative examples are indicated with an asterisk.

TABLE 6

| | Unit | 1* | 2* | 3* | 4* | 5* | 6* | 7 | 8 | 9 |
|---|---|---|---|---|---|---|---|---|---|---|
| PC-1 | wt % | 69.33 | 69.33 | 69.33 | 69.33 | 69.33 | 69.33 | 69.33 | 69.33 | 69.33 |
| PC-2 | wt % | | | | 30 | | | | | |
| PC-3 | wt % | 30 | | | | | | | | |
| PC-4 | wt % | | | | | | | 30 | | |
| PC-5 | wt % | | | | | | | | 30 | |
| PC-6 | wt % | | | | | 30 | | | | |
| PC-7 | wt % | | | | | | 30 | | | |
| PC-8 | wt % | | 30 | | | | | | | |
| PC-9 | wt % | | | | | | | | | 30 |
| PC-Si-1 | wt % | | | 30 | | | | | | |
| UVA-1 | wt % | 0.3 | 0.3 | 0.3 | 0.3 | 0.3 | 0.3 | 0.3 | 0.3 | 0.3 |
| STAB | wt % | 0.1 | 0.1 | 0.1 | 0.1 | 0.1 | 0.1 | 0.1 | 0.1 | 0.1 |
| PETS | wt % | 0.27 | 0.27 | 0.27 | 0.27 | 0.27 | 0.27 | 0.27 | 0.27 | 0.27 |
| Total | wt % | 100 | 100 | 100 | 100 | 100 | 100 | 100 | 100 | 100 |

Properties

| | | | | | | | | | | |
|---|---|---|---|---|---|---|---|---|---|---|
| MVR, 360 s | cm³/10 | 13 | 11.2 | 7.28 | 11.8 | 7.37 | 11 | 13.3 | 12.6 | 6.68 |
| | min | | | | | | | | | |
| MVR, 1080 s | cm³/10 | 13.2 | 11.4 | 7.17 | 11.9 | 7.7 | 10.8 | 14.1 | 13.6 | 6.54 |
| | min | | | | | | | | | |
| App. shear | 1/s | 640 | 640 | 640 | 640 | 640 | 640 | 640 | 640 | 640 |
| rate | | | | | | | | | | |
| App. | Pa · s | 298.1 | 342.6 | 349.7 | 350.3 | 502.1 | 390.8 | 266 | 322.7 | 438 |
| Viscosity | | | | | | | | | | |
| HDT | ° C. | 130.6 | 130.8 | 130.6 | 132.1 | 139.8 | 144.9 | 133.0 | 129.3 | 135.0 |
| 0.45 MPa | | | | | | | | | | |
| Ductility | % | 0 | 0 | 0 | 0 | 0 | 0 | 0 | 0 | 0 |
| Impact | J/m | 55.3 | 53.2 | 80.8 | 47.9 | 48.3 | 34.4 | 34.5 | 43.9 | 45.9 |
| Strength | | | | | | | | | | |
| Modulus of | MPa | 2494 | 2452 | 2164 | 2456 | 2376 | 2524 | 2510 | 2390 | 2396 |
| Elasticity | | | | | | | | | | |
| Tensile | MPa | 77.4 | 77.7 | 65.9 | 74.8 | 76.5 | 80.8 | 76.6 | 72.6 | 75.4 |
| Strength at | | | | | | | | | | |
| Yield | | | | | | | | | | |
| Tensile | MPa | 67.1 | 63.5 | 54.6 | 62.5 | 61.7 | 62.9 | 60.7 | 61.7 | 61.4 |
| Strength at | | | | | | | | | | |
| Break | | | | | | | | | | |
| % Elongation | MPa | 7.5 | 7.5 | 6.8 | 7.5 | 7.9 | 7.8 | 7.3 | 7.4 | 7.6 |
| at Yield | | | | | | | | | | |
| % Elongation | MPa | 51 | 94 | 44 | 88 | 52 | 37 | 53 | 108 | 64 |
| at Break | | | | | | | | | | |
| Transmission | % | 33 | 40 | 43 | 82 | 74 | 74 | 91 | 91 | 89 |
| at 2.5 mm | | | | | | | | | | |
| Haze at | % | 100 | 100 | 100 | 26 | 73 | 53 | 0.7 | 0.9 | 4 |
| 2.5 mm | | | | | | | | | | |

Table 6 shows that compositions containing the DMBPC-BPA copolymer (e.g., PC-i) and an auxiliary polycarbonate in an amount of 30 wt %. Comparative Examples 1-6 show that when the auxiliary polycarbonates include a copolycarbonate comprising BPA carbonate units and 2-phenyl-3,3′-bis(4-hydroxyphenyl) phthalimidine carbonate units (e.g., PC-7); a poly(phthalate-carbonate) (e.g., PC-6), an (isophthalate/terephthalate-resorcinol)-carbonate copolymer (e.g., PC-2), and a (polyester-carbonate) comprising resorcinol, isophthalate, and terephthalate units and BPA carbonate units (e.g., PC-3) failed to provide the desired transparency. Examples 7-9 show that when the auxiliary polycarbonate includes a branched BPA homopolycarbonate (e.g., PC-4, PC-9) or a poly(aliphatic ester-carbonate) comprising BPA carbonate units and sebacic acid-BPA ester units (e.g., PC-5), transparency was maintained.

### Examples 10-16

Table 7 shows the compositions and properties for the following comparative examples and examples. Comparative examples are indicated with an asterisk.

TABLE 7

| | Unit | 10* | 11 | 12 | 13 | 14 | 15 | 16 |
|---|---|---|---|---|---|---|---|---|
| PC-1 | wt % | 99.33 | 79.3 | 59.3 | 79.3 | 59.33 | 79.3 | 59.3 |
| PC-4 | wt % | | 20 | 40 | | | | |
| PC-5 | wt % | | | | 20 | 40 | | |
| PC-9 | wt % | | | | | | 20 | 40 |
| UVA-1 | wt % | 0.3 | 0.3 | 0.3 | 0.3 | 0.3 | 0.3 | 0.3 |
| STAB | wt % | 0.1 | 0.1 | 0.1 | 0.1 | 0.1 | 0.1 | 0.1 |
| PETS | wt % | 0.27 | 0.27 | 0.27 | 0.27 | 0.27 | 0.27 | 0.27 |
| Total | wt % | 100 | 100 | 100 | 100 | 100 | 100 | 100 |
| MVR, 360 s | cm³/10 | 14.3 | 14.6 | 13.8 | 13.4 | 12 | 8.41 | 5.03 |
| | min | | | | | | | |
| MVR, 1080 s | cm³/10 | 14.5 | 14.3 | 13.8 | 14.6 | 12.2 | 8.63 | 5.04 |
| | min | | | | | | | |
| App. shear rate | 1/s | 640 | 640 | 640 | 640 | 640 | 640 | 640 |
| App. Viscosity | Pa · s | 295.7 | 270 | 250 | 318 | 350.7 | 382 | 480 |
| HDT, 0.45 MPa | ° C. | 131.2 | 132.0 | 132.0 | 130.0 | 127.8 | 134.0 | 135.0 |
| HDT, 1.82 MPa | ° C. | 115.9 | 117.0 | 117.0 | 116.0 | 114.3 | 120.0 | 121.0 |
| Ductility | % | 0 | 0 | 0 | 0 | 0 | 0 | 0 |
| Impact Strength | J/m | 32.2 | 32 | 32.7 | 31.5 | 47 | 32.3 | 49.9 |
| Modulus of | MPa | 2460 | 2432 | 2408 | 2342 | 2256 | 2396 | 2308 |
| Elasticity | | | | | | | | |
| Tensile Strength | MPa | 78.8 | 77.3 | 75.6 | 74.6 | 70.5 | 76.2 | 73.3 |
| at Yield | | | | | | | | |
| Tensile Strength | MPa | 61.5 | 60.7 | 61.2 | 58.2 | 63.9 | 60.9 | 65.3 |
| at Break | | | | | | | | |
| % Elongation at | MPa | 8.15 | 7.8 | 7.51 | 7.85 | 7.53 | 8.01 | 7.81 |
| Yield | | | | | | | | |
| % Elongation at | MPa | 53.94 | 47.4 | 39.4 | 74.3 | 111.1 | 61.1 | 97.8 |
| Break | | | | | | | | |
| Transmission at | % | 91 | 90.9 | 91.2 | 90.9 | 90.94 | 91.1 | 91 |
| 2.5 mm | | | | | | | | |
| Haze at 2.5 mm | % | 0.84 | 0.94 | 0.86 | 1.13 | 1.01 | 0.91 | 0.95 |

Table 8 shows that when the wt % of the auxiliary polycarbonates including a branched BPA homopolycarbonate (e.g., PC-4, PC-9) or a poly(aliphatic ester-carbonate) comprising BPA carbonate units and sebacic acid-BPA ester units (e.g., PC-5) are reduced from 30 wt % to 20 wt % and increased from 30 wt % to 40 wt %, that the transparency is maintained (compare: Examples 11 and 12 with Example 7, Examples 13 and 14 with Example 8, and Examples 15 and 16 with Example 9).

### Examples 17-24

Table 9 shows the compositions and properties for the following comparative examples and examples. Comparative examples are indicated with an asterisk.

TABLE 9

| | Unit | 17* | 18 | 19 | 20* | 21* | 22* | 23 | 24 |
|---|---|---|---|---|---|---|---|---|---|
| PC-1 | wt % | 99.25 | 79.37 | 59.37 | 99.67 | 79.57 | 79.57 | 79.57 | 79.57 |
| PC-Si-2 | wt % | | 20 | 40 | | | | | |
| PC-11 | wt % | | | | | | | 20 | |
| PC-12 | wt % | | | | | | 20 | | |
| PC-13 | wt % | | | | | | | | 20 |
| PC-14 | wt % | | | | | 20 | | | |
| UVA-1 | wt % | 0.3 | 0.3 | 0.3 | | | | | |
| MZP | wt % | | | | 0.1 | 0.1 | 0.1 | 0.1 | 0.1 |
| STAB | wt % | 0.05 | 0.06 | 0.06 | 0.03 | 0.03 | 0.03 | 0.03 | 0.03 |
| PETS | wt % | 0.4 | 0.27 | 0.27 | 0.3 | 0.3 | 0.3 | 0.3 | 0.3 |
| Total | wt % | 100 | 100 | 100 | 100 | 100 | 100 | 100 | |
| MVR, 360 s | cm³/10 | 15.1 | 14.5 | 13.1 | 14.3 | 21.7 | 22 | 23.7 | 24.2 |
| | min | | | | | | | | |
| MVR, 1080 s | cm³/10 | | | | 14.4 | 33.3 | 32.4 | 36 | 42.5 |
| | min | | | | | | | | |
| App. shear | 1/s | 640 | 640 | 640 | | | | | |
| rate | | | | | | | | | |
| App. | Pa · s | 289 | 273.8 | 291.3 | | | | | |
| Viscosity | | | | | | | | | |
| HDT, 0.45 | ° C. | 130.8 | 131.3 | 130.8 | 131.8 | 125.0 | 119.6 | 113.5 | 120.0 |
| MPa | | | | | | | | | |
| HDT, 1.82 | ° C. | 114.8 | 116.1 | 117.0 | 116.6 | 107.0 | 104.8 | 99.9 | 105.3 |
| MPa | | | | | | | | | |
| Ductility, | % | 0 | 0 | 0 | 0 | 0 | 0 | 0 | 0 |
| 23 C. | | | | | | | | | |
| Impact | J/m | 29.4 | 39.4 | 54 | 32 | 31.6 | 30.8 | 30.5 | 32.2 |
| Strength, 23 C. | | | | | | | | | |
| Ductility, −30 | % | | | | 0 | 0 | 0 | 0 | 0 |
| C. | | | | | | | | | |
| Impact | J/m | | | | 31.1 | 31.5 | 31.3 | 30 | 31.7 |
| Strength, −30 | | | | | | | | | |
| C. | | | | | | | | | |
| Modulus of | MPa | 2452 | 2316 | 2216 | 2452 | 2436 | 2280 | 2138 | 2250 |
| Elasticity | | | | | | | | | |
| Tensile | MPa | 77.9 | 72.9 | 68.7 | 76.5 | 72.2 | 70.7 | 66.8 | 69.8 |
| Strength at | | | | | | | | | |
| Yield | | | | | | | | | |
| Tensile | MPa | 59.9 | 58.1 | 54.3 | 60.1 | 56.5 | 53.7 | 50.5 | 54.5 |
| Strength at | | | | | | | | | |
| Break | | | | | | | | | |
| % Elongation | MPa | 7.98 | 7.63 | 7.25 | 7.89 | 7.34 | 7.34 | 7.26 | 7.47 |
| at Yield | | | | | | | | | |
| % Elongation | MPa | 61.19 | 81.07 | 77.63 | 64.39 | 91.39 | 47.17 | 49.04 | 79.19 |
| at Break | | | | | | | | | |
| Transmission | % | 90.5 | 89.3 | 89.5 | 91.16 | 33.52 | 83.38 | 89.56 | 89.64 |
| at 2.5 mm | | | | | | | | | |
| Haze at | % | 1.76 | 1.24 | 1.17 | 1.03 | 101 | 11.56 | 2.44 | 1.97 |
| 2.5 mm | | | | | | | | | |

Examples 18-19 show that compositions including a DMBPC-BPA copolymer (e.g., PC-1) included poly(carbonate-siloxane) (e.g., PC-Si-2) as the auxiliary polycarbonate, transparency was maintained. Incorporation of poly(1,4-butylene terephthalate) (e.g., PC-14, see Comparative Example 22) or a copolymer of poly(ethylene terephthalate-co-1,4-cyclohexanedimethylene terephthalate) (e.g., PC-4, see Comparative Example 22) as the auxiliary polycarbonate failed to maintain transparency. Incorporation of poly(1,4-cyclohexane-dimethanol-1,4-cyclohexanedicarboxylate) (e.g., PC-20, see Example 23) or poly(1,4-cyclohexanedimethylene terephthalate) (e.g., PC-13, see Example 24) as the auxiliary polycarbonate maintained transparency.

### Examples 25-29

Table 10 shows the compositions and properties for the following comparative examples and examples. Comparative examples are indicated with an asterisk.

TABLE 10

| | Unit | 25* | 26 | 27 | 28 | 29 |
|---|---|---|---|---|---|---|
| PC-1 | wt % | 99.33 | 79.33 | 59.33 | 39.33 | 19.33 |
| PC-15 | wt % | | 20 | 40 | 60 | 80 |
| UVA (234) | wt % | 0.3 | 0.3 | 0.3 | 0.3 | 0.3 |
| MZP | wt % | | | | 0.1 | 0.1 |
| STAB | wt % | 0.1 | 0.1 | 0.1 | 0.1 | 0.1 |
| PETS | wt % | 0.27 | 0.27 | 0.27 | 0.27 | 0.27 |
| Total | wt % | 100 | 100 | 100 | 100 | 100 |
| MVR, 360 s | cm³/10 | 15 | 10.7 | 5.69 | 3.32 | 2.03 |
| | min | | | | | |
| HDT, 0.45 MPa | ° C. | 132.7 | 143.5 | 152.5 | 164.0 | 178.3 |
| HDT, 1.82 MPa | ° C. | 119.8 | 129.9 | 138.2 | 150.4 | 163.1 |
| Ductility, 23° C. | % | 0 | 0 | 0 | 0 | 0 |
| Impact Strength, | J/m | 31.4 | 31.3 | 33 | 38.1 | 47.3 |
| 23° C. | | | | | | |
| Modulus of | MPa | 2638 | 2574 | 2532 | 2476 | 2422 |
| Elasticity | | | | | | |
| Tensile Strength | MPa | 78.2 | 79.4 | 79.7 | 79.1 | 77.8 |
| at Yield | | | | | | |
| Tensile Strength | MPa | 62.4 | 61.5 | 63.6 | 62.2 | 61.4 |
| at Break | | | | | | |
| % Elongation at | MPa | 7.9 | 7.86 | 7.76 | 7.62 | 7.34 |
| Yield | | | | | | |
| % Elongation at | MPa | 87.6 | 89.1 | 85.28 | 80.16 | 89.96 |
| Break | | | | | | |
| Transmission at | % | 90.46 | 90.8 | 90.68 | 90.26 | 90.34 |
| 2.5 mm | | | | | | |
| Haze at 2.5 mm | % | 3.136 | 1.406 | 0.984 | 0.886 | 0.504 |

Table 10 shows that molded samples of compositions that include a copolymer comprising BPA carbonate units and isophorylidene bisphenol carbonate units as the auxiliary polycarbonate maintained transparency.

This disclosure further encompasses the following aspects.

Aspect 1. A composition comprising: a copolycarbonate comprising repeating units derived from a cyclohexylidene-bridged bisphenol; and an auxiliary polycarbonate comprising a branched homopolycarbonate; a poly(1,4-cyclohexanedimethylene terephthalate), a copolycarbonate comprising repeating units derived from an isophorylidene-bridged bisphenol, or a combination thereof, and optionally a poly(alkylene cyclohexanedicarboxylate), a poly(carbonate siloxane) having a siloxane content of less than 20 wt % based on the total weight of the poly(carbonate-siloxane), a poly(aliphatic ester-carbonate) comprising bisphenol A carbonate units and C₆₋₁₂ dicarboxy ester units; or a combination thereof, wherein the branched polycarbonate comprises greater than or equal to 0.1 mole % of moieties derived from a branching agent based on the total moles of the polycarbonate and optionally comprises end-capping groups, and optionally an additive composition, wherein a molded sample of the composition has a transparency of 89% or greater as measured using 2.5 mm plaques according to ASTM-D1003-00.

Aspect 1a. The composition of Aspect 1, wherein the auxiliary polycarbonate comprises a poly(1,4-cyclohexanedimethylene terephthalate), a copolycarbonate comprising repeating units derived from an isophorylidene-bridged bisphenol, or a combination thereof, and optionally a poly(alkylene cyclohexanedicarboxylate), a poly(carbonate siloxane) having a siloxane content of less than 20 wt % based on the total weight of the poly(carbonate-siloxane), a poly(aliphatic ester-carbonate) comprising bisphenol A carbonate units and C₆₋₁₂ dicarboxy ester units; a branched homopolycarbonate; or a combination thereof.

Aspect 2. The composition of Aspect 1a or 1b, wherein the copolycarbonate comprising repeating units derived from a cyclohexylidene-bridged bisphenol has the formula:

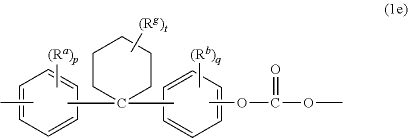

wherein R^{a} and R^{b} are each independently C₁₋₁₂ alkyl, R^{g} is C₁₋₁₂ alkyl, p and q are each independently 0 to 4, and t is 0 to 2.

Aspect 3. The composition of any one of the preceding aspects, wherein the copolycarbonate derived from a cyclohexylidene-bridged bisphenol is derived from 1,1-bis(4-hydroxy-3-methylphenyl)cyclohexane, the copolycarbonate derived from an isophorylidene-bridged bisphenol is derived from 1,1-bis(4-hydroxy-phenyl) 3,3,5-trimethyl-cyclohexane, or a combination thereof.

Aspect 4. The composition of any of Aspect 1 to 3, wherein the auxiliary polycarbonate comprises a poly(aliphatic ester-carbonate) and wherein a molded sample of the composition has: a heat deformation temperature (HDT) of at least 111° C. at 0.45 MPa or at least 98° C. at 1.82 MPa as determined on one-eighth inch (3.18 mm) bars per ASTM D648.

Aspect 5a. The composition of any of Aspect 1, 1a, 2 or 3, wherein the auxiliary polycarbonate comprises a branched homopolycarbonate; a poly(1,4-cyclohexanedimethylene terephthalate), a copolycarbonate comprising repeating units derived from an isophorylidene-bridged bisphenol, or a combination thereof, and optionally a poly(alkylene cyclohexanedicarboxylate), a poly(carbonate siloxane) having a siloxane content of less than 20 wt % based on the total weight of the poly(carbonate-siloxane), or a combination thereof, and wherein a molded sample of the composition has: a heat deformation temperature (HDT) of at least 127° C. at 0.45 MPa or at least 110° C. at 1.82 MPa as determined on one-eighth inch (3.18 mm) bars per ASTM D648.

Aspect 5b. The composition of any of Aspect 1, 1a, 2, and 3, wherein the auxiliary polycarbonate comprises a poly(1,4-cyclohexanedimethylene terephthalate), a copolycarbonate comprising repeating units derived from an isophorylidene-bridged bisphenol, or a combination thereof, and optionally a poly(alkylene cyclohexanedicarboxylate), a poly(carbonate siloxane) having a siloxane content of less than 20 wt % based on the total weight of the poly(carbonate-siloxane), a branched homopolycarbonate; or a combination thereof, and wherein a molded sample of the composition has: a heat deformation temperature (HDT) of at least 127° C. at 0.45 MPa or at least 110° C. at 1.82 MPa as determined on one-eighth inch (3.18 mm) bars per ASTM D648.

Aspect 6. The composition of any one of the preceding aspects, wherein the end-capping groups comprise a phenol optionally substituted with a cyano group, an aliphatic group, an olefinic group, an aromatic group, a halogen, an ester group, an ether group, or a combination thereof.

Aspect 7. The composition of Aspect 6, wherein the branching agent comprises trimellitic trichloride, 1,1,1-tris(4-hydroxyphenyl)ethane, or a combination of trimellitic trichloride and 1,1,1-tris(4-hydroxyphenyl)ethane.

Aspect 8. The composition of Aspect 6 or Aspect 7, wherein the end-capping agent is phenol, p-t-butylphenol, p-methoxyphenol, p-cyanophenol, p-cumylphenol, or a combination thereof.

Aspect 9. The composition of any one of the preceding aspects, wherein the poly(aliphatic ester-carbonate) comprises sebacic acid-bisphenol A ester units and bisphenol A carbonate units having an average molar ratio of ester units to carbonate units of 2:98 to 8:92.

Aspect 10. The composition of any one of the preceding aspects, wherein the poly(alkylene cyclohexanedicarboxylate) is present and has repeating units of the following formula

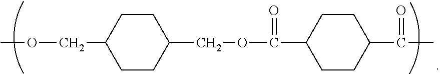

Aspect 11. The composition of any one of Aspects 2 to 10 comprising a copolycarbonate comprising repeating units derived from a cyclohexylidene-bridged bisphenol and bisphenol carbonate units; and a branched bisphenol A homopolycarbonate as the auxiliary polycarbonate.

Aspect 12. The composition of any one of Aspects 2 to 10 comprising a copolycarbonate comprising repeating units derived from a cyclohexylidene-bridged bisphenol and bisphenol carbonate units; and a poly(aliphatic ester-carbonate) comprising sebacic acid-bisphenol A ester units and bisphenol A carbonate units having an average molar ratio of ester units to carbonate units of 2:98 to 8:92.

Aspect 13. The composition of any one of Aspects 2 to 10 comprising a copolycarbonate comprising repeating units derived from a cyclohexylidene-bridged bisphenol and bisphenol carbonate units; and a copolycarbonate comprising repeating units derived from an isophorylidene-bridged bisphenol and bisphenol carbonate units.

Aspect 14. An article comprising the composition of any one of the preceding aspects.

Aspect 15. A method for forming the article according to Aspect 14, comprising molding, casting, or extruding the composition to provide the article.

The compositions, methods, and articles may alternatively comprise, consist of, or consist essentially of, any appropriate materials, steps, or components herein disclosed. The compositions, methods, and articles may additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt % to 25 wt %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property not listed

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

The term “alkyl” means a branched or straight chain, unsaturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O-), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃-)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo groups (e.g., bromo and fluoro), or only chloro groups may be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that may each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl) a thiol (—SH), a thiocyano (—SCN), a tosyl(CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example—CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A composition comprising:
a copolycarbonate comprising repeating units derived from a cyclohexylidene-bridged bisphenol; and
an auxiliary polycarbonate comprising a branched homopolycarbonate, a poly(1,4-cyclohexanedimethylene terephthalate), a copolycarbonate comprising repeating units derived from an isophorylidene-bridged bisphenol, or a combination thereof, and optionally a poly(alkylene cyclohexanedicarboxylate), a poly(carbonate siloxane) having a siloxane content of less than 20 weight % based on the total weight of the poly(carbonate-siloxane), a poly(aliphatic ester-carbonate) comprising bisphenol A carbonate units and C₆₋₁₂ dicarboxy ester units, or a combination thereof;
wherein the branched homopolycarbonate comprises greater than or equal to 0.1 mole % of moieties derived from a branching agent based on total moles of the polycarbonate, and optionally comprises end-capping groups;
optionally, an additive composition, and
wherein a molded sample of the composition has a transparency of 89% or greater as measured using 2.5 mm plaques according to ASTM-D1003-00.

2. The composition of claim 1, wherein the copolycarbonate compris repeating units derived from a cyclohexylidene-bridged bisphenol that has the formula: 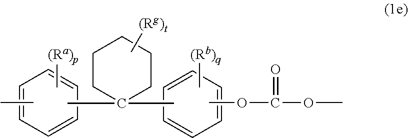
wherein
R^{a} and R^{b} are each independently C₁₋₁₂ alkyl, R^{g} is C₁₋₁₂ alkyl,
p and q are each independently 0 to 4, and
t is 0 to 2.

3. The composition of claim 1, wherein the copolycarbonate derived from a cyclohexylidene-bridged bisphenol is derived from 1,1-bis(4-hydroxy-3-methylphenyl)cyclohexane, the copolycarbonate derived from an isophorylidene-bridged bisphenol is derived from 1,1-bis(4-hydroxy-phenyl) 3,3,5-trimethyl-cyclohexane, or a combination thereof.

4. The composition of claim 1, wherein the auxiliary polycarbonate comprises a poly(aliphatic ester-carbonate), and
wherein a molded sample of the composition has:
a heat deformation temperature of at least 111° C. at 0.45 MPa, or at least 98° C. at 1.82 MPa as determined on one-eighth inch (3.18 mm) bars per ASTM D648.

5. The composition of claim 1, wherein the auxiliary polycarbonate comprises
a branched homopolycarbonate, a poly(1,4-cyclohexanedimethylene terephthalate), a copolycarbonate comprising repeating units derived from an isophorylidene-bridged bisphenol, or a combination thereof, and
optionally a poly(alkylene cyclohexanedicarboxylate), a poly(carbonate siloxane) having a siloxane content of less than 20 wt % based on the total weight of the poly(carbonate-siloxane), or a combination thereof,
wherein a molded sample of the composition has a heat deformation temperature of at least 127° C. at 0.45 MPa or at least 110° C. at 1.82 MPa as determined on one-eighth inch (3.18 mm) bars per ASTM D648.

6. The composition of claim 1, wherein the branched polycarbonate comprises end-capping groups derived from an end-capping agent that is a phenol, optionally substituted with a cyano group, an aliphatic group, an olefinic group, an aromatic group, a halogen, an ester group, an ether group, or a combination thereof.

7. The composition of claim 1, wherein the branching agent comprises trimellitic trichloride, 1,1,1-tris(4-hydroxyphenyl)ethane, or a combination of trimellitic trichloride and 1,1,1-tris(4-hydroxyphenyl)ethane.

8. The composition of claim 6, wherein the end-capping agent is phenol, p-t-butylphenol, p-methoxyphenol, p-cyanophenol, p-cumylphenol, or a combination thereof.

9. The composition of claim 1, wherein the poly(aliphatic ester-carbonate) is present and comprises sebacic acid-bisphenol A ester units and bisphenol A carbonate units having an average molar ratio of ester units to carbonate units of 2:98 to 8:92.

10. The composition of claim 1, wherein the poly(alkylene cyclohexanedicarboxylate) is present and has repeating units of the following formula

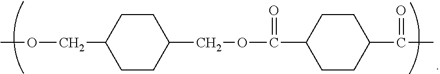

11. The composition of claim 2 comprising
a copolycarbonate comprising repeating units derived from a cyclohexylidene-bridged bisphenol and bisphenol carbonate units; and
a branched bisphenol A homopolycarbonate as the auxiliary polycarbonate.

12. The composition of claim 1 comprising
a copolycarbonate comprising repeating units derived from a cyclohexylidene-bridged bisphenol and bisphenol carbonate units; and
a poly(aliphatic ester-carbonate) comprising sebacic acid-bisphenol A ester units and bisphenol A carbonate units having an average molar ratio of ester units to carbonate units of 2:98 to 8:92.

13. The composition of claim 1 comprising
a copolycarbonate comprising repeating units derived from a cyclohexylidene-bridged bisphenol and bisphenol carbonate units; and
a copolycarbonate comprising repeating units derived from an isophorylidene-bridged bisphenol and bisphenol carbonate units.

14. An article comprising the composition of claim 1.

15. A method for forming the article according to claim 14, comprising molding, casting, or extruding the composition to provide the article.
